(19) United States
(12) Patent Application Publication
(10) Pub. No.: US 2002/0169270 A1
(43) Pub. Date: Nov. 14, 2002

(54) Film-forming specifically detachable material

(76) Inventors: Sabine Amberg-Schwab, Erlabrunn (DE); Rozalija Crnobrnja, Wurzburg (DE); Karl-Heinz Haas, Veitshochneim (DE)

Correspondence Address: BRINKS HOFER GILSON & LIONE, One Indiana Square, Suite 2425, Indianapolis, IN, 46204, US

(21) Appl. No.: 10/138,762

(22) Filed: May 3, 2002

Related U.S. Application Data
(62) Division of application No. 09/367,763, filed on Nov. 17, 1999, now abandoned.

(30) Foreign Application Priority Data
Dec. 23, 1997 (DE) 197 57 455.6
May 20, 1998 (DE) 198 22 721.3

(51) Int. Cl. C08G 77/00

(52) U.S. Cl. 528/10

(57) ABSTRACT

The invention relates to a film-forming material that contains an inorganic/organic hybrid polymer and/or hybrid pre-polymer. The film-forming specifically detachable material of the present invention is useful for the temporary stabilizing and/or functionalizing of technical or biological surfaces and additionally contains at least one film-forming water- and or alcohol-soluble polymer. The material of the present invention is generally one in which the hybrid polymer or hybrid pre-polymer, is formed through hydrolitic precondensation, possibly in the presence of at least one condensation catalyst, of at least one organofunctional silane of the formula (I)

RSiX₃ (I)

wherein X stands for a hydrolizable and condensable group and R for a networkable organic residue. A colloidal solution is formed and applied to a desired surface to precipitate the colloid and cause networking of the hybrid pre-polymers with each other to form the specifically detachable, film-forming material on the desired surface.

The present invention concerns a film-forming specifically detachable material for the temporary stabilizing and/or functionalizing of technical or biological surfaces on the basis of inorganic/organic hybrid polymers and film-forming water- and/or alcohol-soluble polymers.

For the coating of surfaces, numerous materials are known. As coating material for scratch resistant coatings, so-called “ORMOCERE” has been used for some years. The compound class of ORMOCERE concerns inorganic/organic hybrid polymers, whose composition is selected depending on desired characteristics. One of the remarkable features of these materials is a good adhesion to a substrate, e.g., metal or glass. In addition, excellent scratch resistance is achieved. Such materials are described for example in DE-OS-38 28 098 as well as in EP 0 610 83 1.

In contrast to the above-described materials, numerous film-forming water-soluble polymers are known the way technology stands. Film-forming reinforcers are used, e.g., for fibers, especially for hair.

For example polyvinyl pyrrolidone, polyvinyl pyrrolidone/polyvinylacetate copolymer, polyacrylate or polymethacrylacidpolymerisate are considered synthetic polymers. Of the natural polymers for example shellac, gelatin, chitosan salts, polysaccharides and derivatives, cellulose and cellulose derivatives are used.

Furthermore it is known to use silicones for the treatment of fibers, like textile fibers and hair, e.g., low viscosity, organic functionalized silicones (GB 2297757 A). In U.S. Pat. No. 5,602,224, silicones are described, which carry a quaternary ammonium group, wherein hydrocarbon chains or groups (CI-C20) are bound at the nitrogen. Through this, a solubility in non-polar solvents is supposed to be achieved. In U.S. Pat. No. 5,389,364 amino-functionalized silicones are described for the treatment of hair.

But the above described materials are not suitable for a temporary coating because they are either structured for long-lasting adhesion (ORMOCERE) or detach themselves from the substrate too easily like the synthetic polymers.

But there are numerous cases of application where it is desirable that a material is available for the coating of substrates like textile materials, fibers, natural products, or also technical substrates like sheet metals or wood, where the coating can be intentionally removed, i.e., under previously determined conditions. Here we mention, e.g., flat substrates, which, e.g., undergo a transformation process, for which a temporary layer can function as a lubricant. In this case the coating has to be done in such a way that the coating can be removed after the transformation process. Another possible application is that of textiles that can be structured in specific places with the coating material and then in a subsequent dying process only the non-structured areas are dyed. In a subsequent process the coating material can be removed from the textile material in a specific removal process. Another possible application would also be a temporary corrosion protection. Here there are many possible applications especially with intermediate products in which the-metallic material has to undergo a corrosion protection, which then has to be removed before further processing of the intermediate products to the end product. Especially in those cases where oily corrosion protection substances are used, this is not always achieved to full satisfaction. Also a transport protection with such a coating material is conceivable. A further area of application is to be seen in the coating, i.e., in the reinforcing of fibers, here, e.g., of hair. Because of such a coating material, a temporary strengthening of hair could be achieved, which could be eliminated afterwards with a specific washing.

On this basis, it is a goal of the present invention to offer a new coating material that on the one hand makes the reinforcing of substrates possible and that on the other hand can be deliberately removed again.

The goal is achieved because of the characteristic features of the film-forming specifically detachable material of the present invention useful for the temporary stabilizing and/or functionalizing of technical or biological surfaces containing at least one inorganic/organic hybrid polymer and/or hybrid pre-polymer and containing in addition at least one film-forming water- and or alcohol-soluble polymer. The material of the present invention is generally one in which the hybrid polymer, i.e., hybrid pre-polymer, is formed through hydrolitic precondensation, possibly in the presence of at least one condensation catalyst, of at least one organofunctional silane of the formula (I)

RSiX₃ (I)

wherein X stands for a hydrolizable and condensable group and R for a networkable organic residue.

In accordance with this invention a material is proposed that consists of inorganic/organic hybrid polymers, i.e., of so called ORMOCERE and at the same time of water- and/or alcohol-soluble polymers. Because of this, it is possible to produce coatings, which on the one hand show a good adhesion to the substrate and which on the other hand can be removed again. Through the network of the polymers or rather the pre-polymers on the substrate, e.g., the textile material, the flat metal or the hair, the polymers are better bound with the substrate and therefore can cause a stabilizing. Depending on the substrate, a direct binding of the polymer is possible, e.g., through mercapto groups or SiOH-groups to the substrate, e.g., to the fibers. Because of the possibility of a covalent bond between the hybrid polymers and the polymers, a good mixability/compatibility in extremely different mixing ratios exists. This means that mixtures of polymers and inorganic/organic hybrid polymers, which are applied on fibers, e.g., natural fibers, show a very good adhesive characteristic and durability. At the same time a great variability regarding the solubility of the systems is achievable because of the choice of the film-forming water- and/or alcohol-soluble polymers.

The inorganic/organic hybrid polymers in accordance with the invention are all also called ORMOCER'e. They are heteropolysiloxanes which take a special position between the classically defined inorganic glasses (silicates) and organic networked polymers. The hybrid polymers can be produced in the so-called sol-gel-process and are known as coating materials for metals, glasses, stones, polymers etc. (Frauenhofer-lnstitute for Silicate Research (ISQ, Tätigkeitsbericht 1993, pages 51 to 60 and the quoted literature there). Further overviews on the process, use and characteristics of inorganic-organic hybrid polymers are described in “Sintesis y preparación de materiales híbridos orgánico/inorgánico. Ormoceros. Nuevas aplicaciones de los materiales polimeros”; Revista de Plásticos Modemos, number 483, September 1996, pages 257 to 274 and quoted literature there as well as in “ORMOCER: Neuer Korrosionsschutz für Messingoberflächen”, Jahrbuch Oberfliichentechnik (1993), 49, pages 243 to 251, as well as the magazine Gummi, Fasern Kunststoff GAK/2/97,5Q p. 102-110.

Procedures for the production of inorganic/organic hybrid polymers and pre-polymers as well as their use as coating material for among others metal surfaces or fabric made of natural fibers are described for example in the DE-OS 38 28 098, U.S. Pat. No. 5,353,706, U.S. Pat. No. 5,409,609, EP 0 610 83 1, EP 0 792 846 and in the U.S. Pat. No. 5,932,291.

For the synthesis of hybrid polymers, functionalized silanes of the general formula (I)

RSiX₃ (I)

are used, wherein X stands for a hydrolizable and condensable group and R for a networkable organic residue. Through hydrolytic precondensation, first the inorganic Si—O—Si-network is formed, which afterwards is further networked through reactions of the networkable organic R groups. With hybrid polymers, in accordance with the invention presented here, products obtained through precondensation are intended which are not yet networked with the R-groups.

The networkable residue R denotes a mostly aliphatic side group, which can contain different functionalities like amino-, epoxy-, hydroxy, methacrylate-, or other polymerizable groups. R can in particular be chosen from alkyl, alkenyl, alkynyl, aryl, arylalkyl, alkylaryl, arylalkenyl, alkenylaryl, alylalkynyl, alkynylaryl, wherein the residue can be broken with O-, S- or N- atoms and, if it is not already networkable in itself, contains at least one networkable substituent of the group of halogens, amino-, amide, aldehyde-, keto-, alkylcarbonyl-, carboxy-, mercapto-, cyano, hydroxy-, alkoxy, methacryloxy-, epoxy- or vinyl-groups.

The groups X can independently represent alkoxy, aryloxy, acyloxy-, alkylcarbonyl-, alkoxycarbonyl-groups, halogens, hydrogen or substituted or unsubstituted aminogroups, wherein ethoxy- and methoxy-groups are especially preferred.

The silane of formula (I) can be in particular chosen out of vinyl trialkoxysilane, vinyl triacetoxysilane, amino propyl trialkoxysilane, isocyanato propyl trialkoxysilane, merecapto propyl trialkoxysilane, vinyl trichlorsilane, allyl trialkoxysilane, 3-isocyanato oxypropyl trialkoxysilane, methacryl oxypropenyl trialkoxysilane, 3-methacryl carbonyl oxypropyl trialkoxysilane, p-amino phenyl trialkoxysilane, 3-amino propyl trialkoxysilane, 3-cyano propyl trialkoxysilane, 4-mercapto butyl trialkoxysilane, 6-mercapto hexyl trialkoxysilane, 3-mercapto propyl trialkoxysilane, 3-(ethylendiamino)-propyl trialkoxysilane, 3-(diethylene triamino)-propyl trialkoxysilane, 3-glycidoxy propyl trialkoxysilane, 2-[4-(1,2-epoxy cyclohexyl)]ethyl trialkoxysilane and 3-(trialkoxysilyl) propyl succinic anhydride, wherein alkoxy groups mean methoxy- or ethoxy- groups. Especially preferred are 3-glycidoxy propyl trialkoxysilane and 3-mercapto propyl trialkoxysilane.

Instead of the monomer silanes, precondensed reaction medium soluble oligomers of the silanes can also be used. Furthermore, fluorinated derivatives of the silanes can also be used.

The compounds of the general formula (I) can be combined with metal compounds like, for example, the alkyl-, alkoxy-, halogen-, acyloxy-, hydroxy-, oxyhalogen- or hydroxyhalogen-compounds of titanium, zirconium, or aluminum, as well with further, network modifying compounds, for example of the formula SiX₄ (II) or compounds of the formula SiR′X₂R (III), wherein R′ stands for a non-networkable and non-condensable alkyl-, or aryl-group and R and X have the above cited meanings.

The network modifying compounds can cause, for example, in case of compounds of the formula (II) an-increase in networkability in the inorganic part, or in case of compounds of the type (III) a decrease.

The metal compounds of the transition metals especially of the group IV A, preferably Ti- or Zr-compounds or groups III B or IV B especially Al-compounds can be especially chosen from tetrachlorotitanium, tetraalkoxytitanium, tetrachlorzirconium, tetraalkoxyzirconium, dichlorzirconium oxide, trialkoxyaluminium and dihydroxyaluminium chloride, tributoxyaluminium and tetrapropoxyzirconium, wherein alkoxy stands for methoxy, ethoxy, i- or n-propoxy, butoxy or 2-ethylhexoxy.

The compound of the formula (II) can be chosen especially from tetramethoxysilane, tetraethoxysilane, trimethoxysilane, tetra-n- or tetra-i-propoxysilane, tetrabutoxysilane, tetrachlorosilane, trichlorosilane, or tetraacetoxysilane.

Further network modifying compounds can be chosen in addition from methyl trichlorsilane, methyl trialkoxysilane, ethyl trichlorosilane, ethyl trialkoxysilane, propyl trialkoxysilane, phenyl trialkoxysilane, dimethyl dichlorosilane, dimethyl dialkoxysilane, dimethyl dihydroxysilane, diphenyl dialkoxysilane, tripropyl hydroxysilane, 4-aminobutyl methyl dialkoxysilane, amino methyidimethyl alkoxysilane, vinylethyl dichlorosilane, vinylmethyl diacetoxysilane, vinylmethyl dichlorosilane, vinylmethyl dialkoxysilane, phenylvinyl dialkoxysilane, phenylallyl dichlorosilane, 4-aminobutylmethyl dialkoxysilane and aminomethyldimethyl alkoxysilane and comparable compounds, wherein alkoxygroups preferably mean methoxy or ethoxy groups.

Production and application of the inorganic/organic hybrid polymers occurs, by adding the film-forming polymers, through the hydrolysis of the reactants to a colloidal solution, for example one which contains alcohols and is also called lacquer. This lacquer can for example be applied directly onto the substrate (e.g., hair, skin or nails). In a second step the network of the organic molecule groups occurs with each other after the forming of the inorganic Si—O—Si-network. This can occur through conventional polymerizing reactions, for example through reactions of double bonds. Also poly-additions, as they are known, of epoxy resin, can be used to network organic side chains.

Preferably the precondensation occurs in the presence of a condensation catalyst. As condensation catalysts protones or compounds that split off hydroxyl ions and amines. With regard to the process engineering with precondensation, reference is made to DE-OS 38 28 098. The present invention includes also the condensation catalysts named in the above-mentioned publication.

The film-forming and reinforcing polymer can be of synthetic or natural origin and can have a nonionic, cationic, anionic or amphoteric character. Such an addition of a polymer, which is present in the material in amounts of 0.01 to 50 weight-%, preferably in amounts of 0.01 to 20 weight-%, can also consist of a mixture of several polymers and be further modified in its reinforcing characteristics through the addition of further polymers with a thickening effect.

Film-forming, reinforcing polymers, as polymers are understood, in accordance with this invention in an application of, e.g., 0.01 to 5% in aqueous, alcoholic or aqueous-alcoholic solution, are able to precipitate on the substrate, e.g., the hair, a polymer film and in this way reinforce the substrate.

As suitable synthetic, non-ionic, film-forming, reinforcing polymers homopolymers of the vinyl pyrrolidones, homopolymers of the N-vinylformamids, copolymerisate out of vinylpyrrolidone and vinylacetate and vinylpropionate, polyacrylamide, polyvinylalcohols, or polyethylenglycol with a molecular weight of 800 to 20,000 g/mol can be used in the material in accordance with this invention.

Among suitable synthetic, film-forming anionic polymers are to be named crotonaic acid/vinylacetate copolymer and terpolymer from acrylacid, ethylacrylate and N-t-butylacrylamid.

Natural film-forming polymers or polymers derived from those in a chemical transformation can also be used in the material in accordance with the invention. Proven to be worthwhile are low-molecular-weight chitosan, mixtures of oligo, mono- and disaccharides, chinese balsamic resin, cellulose derivatives like hydroxy propylcellulose with a molecular weight of 30,000 to 50,000 g/mol, or shellac in neutralized or un-neutralized form.

Also amphoteric polymers can be used in the material in accordance with the invention. Suitable are for example copolymers from octylacrylamid, t-butyl aminoethyl methacrylate as well as two or more monomers from the group acrylic acid, methacrylic acid and their simple esters.

Among the cationic polymers, which can be used in accordance with the invention, are named copolymers of the vinyl pyrrolidones with quaternized derivatives of the dialkyl aminoacrylates and methacrylates, like, for example, with diethylsulfate quaternized vinyl pyrrolidone/dimethylaminomethacrylate copolymers. Further cationic polymers are for example the copolymerisate of the vinyl pyrrolidone with vinyl imidazoliummethochloride, the terpolymer from dimethyl diallyl ammoniumchloride, sodiumacrylate and acrylamide, the terpolymer from vinyl pyrrolidone, dimethyl aminoethyl, methacrylate and vinyl carprolactam, the quaternized ammonium salt, produced from hydroxy ethyl cellulose and one with trimethylammonium substituted epoxide, the vinyl pyrrolidone/methacryl amido propyltrimethyl ammonium chloride copolymer and diquaternary polydimethylsiloxanes.

The consistency of the material-in accordance with the invention can be increased through the addition of thickeners. For this, for example, homopolymers of the acrylic acid are suitable with a molecular weight of 2,000,000 to 6,000,000 g/mol. Also copolymers from acrylic acid and acrylamide (sodium salt) with a molecular weight of 2,000,000 to 6,000,000 g/mol and sclerotium gum are suitable. Also suitable are copolymers of the acrylic acid and the methacrylic acid.

When applying in the biological area, e.g., hair, further known cosmetic additives can be added to the material in accordance with the invention, for example non-reinforcing, non-ionic polymers like polyethylene glycol with a molecular weight of about 600 g/mol, non-reinforcing, anionic and natural polymers as well as mixtures of them in an amount of preferably 0.01 to 50 weight-%. Also perfume oils in an amount of 0.01 to 5 weight-%, clouding substances like ethyleneglycedistearate in an amount of 0.01 to 5 weight-%, network substances or emulsifiers from the classes of the anionic, cationic, amphoteric or non-ionic surfactant like fatty alcohol sulfate, ethoxylized fatty alcohols, fatty acid alkanolamides like the ester or hydrated ricinoleic fatty acids in an amount of 0.1 to 30 weight-%, in addition moisturizing substances, dyes, light protection substances, antioxidants and preservatives in an amount of 0.01 to 10 weight-%.

The material in accordance with the invention can be further improved through the addition of common silicone polymers, like, for example, polydimethyl siloxane (INCl: dimethicon), a-hydro-w-hydroxy polyoxydimethylsilylene (INCl: Dimethiconol), cyclic dimethylpolysiloxane (INCl: Cyclomethicon), trimethy(octadecyloxy)silane (INCl: Stearoxytrimethylsilan), dimethylsiloxane/glycol copolymer (INCl: Dimethicon Copolyol), dimethylsiloxane/aminoalkylsiloxane copolymer with hydroxy-end groups (INCl: Amodimethicon), monomethyl polysiloxane with lauryl-side chains and polyoxyethylene- and/or polyoxypropylene-end chains, (INCl: Laurylmethicon Copolyol), dimethylsiloxane/glycol copolymeracetate (INCl: Dimethiconcopolyol Acetat), dimethylsiloxane/aminoalkylsiloxane copolymer with trimethylsilyl-end chains (INCl: Trimethylsilylamodimethicon). Preferred silicone polymers are dimenthicones, cyclomethicones and dimethiconoles.

The above terms given in parentheses correspond with INCl nomenclature (International Cosmetic Ingredients), as they are determined for the labeling of cosmetic active and aiding substances.

The use of inorganic/organic hybrid polymers, e.g., for the treatment of hair can occur in the following way, under the addition of the film-forming polymers, in a first step a hydrolytic precondensation, possibly in the presence of at least one condensation catalyst, occurs on at least one organo-functional silane of formula (I) and in a second step forms a network to the hybrid polymer. The network can in the course of this be induced through warmth, through light, or through suitable common polymerization initiators. The networking occurs preferably after the application to the hair. Also, systems can be chosen which network without an initiator (e.g., thermic), which is especially advantageous when applying to hair.

The hybrid polymers offer in the form of the inorganic network (precondensate of the first reaction step) the possibility to work themselves into substances for the reinforcing and care of hair in aquatic, alcohol or aquatic/alcohol basis and to be applied to the hair. Through the influence of heat the organic network is formed on the hair and thus fixates the hair. Depending on how the characteristics of this polysiloxane are determined, a firmer or more well-groomed hold of the hair is achieved as well as a pleasant, natural feel with a lot of shine.

Preferred systems for the formation of inorganic organic hybrid polymers are:

1.) 236.4 g 3-glycidoxypropyl-trimethoxysilane,

152.2 g 3-triethoxysilylpropyl-amberacid-hydrid,

4.12 g 1-methylinidazol;

2.) 230.4 g 3-glycidoxypropyl-trimethoxysilane,

297.43 g trimethoxy-phenylsilane,

166 g aminosilane,

738.90 g tributoxyaluminium,

390 g acetic acid ethylester;

3.) 47.8 g 3-glycidoxypropyl-trimethoxysilane,

23.9 g tetramethyoxysilane,

11.20 g tributoxyaluminium,

19.57 g tetrapropoxyzirconium,

9.4 g triethanolamine;

4.) 21.4 g 3-glycidoxypropyl-trimethoxysilane,

2.9 g trimethoxyphenylsilane,

1.49 g 2,2,2-trifluoroethylamine,

7.4 g tributoxyaluminium,

3.9 g acetic acid ethylester;

5.) 993.36 g 3-methacryloxy propyl trimethoxysilane,

341.23 g tetrapropoxyzirconium,

UV-initiator or thermal initiator;

6.) 42.5 g 3-glycidoxypropyl-trimethoxysilane,

5.94 g trimethoxyphenylsilane,

6.6 g aminosilane,

14.7 g tributoxyaluminium,

7.8 g acetic acid ethylester;

7.) 63.810 g 3-glycidoxypropyl-trimethoxysilane,

27.39 g trimethoxyphenylsilane,

6.64 g aminosilane,

14.78 g tributoxyaluminium,

25.59 g tetrapropoxyzirconium;

b 8.) 127.69 g 3-glycidoxypropyl-trimethoxysilane,

6.64 g aminosilane,

47.69 g 3-mercapto propyl triethoxysilane;

9.) mercapto propyl triethoxysilane, diluted hydrochloric acid;

10.) 212.71 g 3-glycidoxypropyl-trimethoxysilane,

59.84 g trimethoxy phenylsilane,

73.89 g tributoxy aluminium,

39.040 g acetic acid ethylester.

11.) 237.4 g mercapto propyl triethoxysilane,

190 g vinyl triethoxysilane, aquatic hydrochloric acid.

Especially preferred are the systems 3.), 9.) and 11.).

The application of the film-forming substance in accordance with the invention for hair occurs in such a way that a) a not yet networked precondensation product of an inorganic/organic hybrid polymer is, under addition of a film-forming polymer, applied to the substrate, e.g., hair, in a suitable cosmetic base and b) afterwards networked to a hybrid polymer.

The networking can in this case be induced through heat, light with or without initiator according to the system. Suitable initiators are for example 1-hydroxy cyclohexyl phenylketone or tert.-butylperoxy-2-ethyl hexanoate. A thermally induced networking occurs preferably at 20 to 80° C. within preferably 2 to 20 minutes.

In the material in accordance with the invention the hybrid polymer is present in an amount of preferably 0.01 to 40 weight-%, especially preferred in an amount of 0.05 to 15 weight-% in a suitable cosmetic base. The portion of the film-forming polymer is 0.1-50%.

The material in accordance with the invention exists in general as aquatic, alcoholic or aquatic-alcoholic solution. Suitable solvents are for example aliphatic alcohols with 1 to 4 carbon atoms or a mixture of water with one of the above alcohols. Though other organic solvents can be used also, wherein especially unbranched or branched hydrocarbons like pentane, hexane, isopentane and cyclic hydrocarbons like cyclopentane and cyclohexane are to be used. The solvents exist in an amount of 0.5 to 99 weight-%, preferably in an amount of 40 to 90 weight-%.

The material in accordance with the invention can find applications in different forms, like, for example, in aerosol preparation as foam or as spray, further as a non-aerosol, which can be deployed via a pump or as “Pump and Spray”. The deployment in common with or without emulsions is also possible like in form of lotion, milk, liquid reinforcer, creme, gel, gel foam, wax or microemulsion.

The application of the material in accordance with the invention can occur for the different applications in the most different ways. The material in accordance with the invention can be used for the coating of flat substrates, the material can, as above described, be applied to the substrate in the form of a solution with common coating techniques like, e.g., dipping, spraying or varnishing. To the material in accordance with the invention can be added commonly known formulating particles like pigments or colors.

The material in accordance with the invention can also be formulated as coloring or conditioning hair treatment substance like for example as color fastener and hair rinse. When the material in accordance with the invention is present in form of an aerosol-hairspray or aerosol-hair lacquer, it then contains additionally 15 to 85 weight-%, preferably 25 to 75 weight-%, of a propellant and is filled in a pressure container. As propellants are suitable for example low alkanes, as for example n-butane, i-butane and propane, or also their mixtures with dimethylether as well as other propellants, which are gases at these pressures like for example N₂, N₂O and CO₂ as well as mixtures with the above propellants.

The material in accordance with the invention for the fastening of hair can also be present in form of a sprayable non-aerosol-hairspray or a non-aerosol-hair lacquer with the help of a suitable mechanically operated spraying device. Mechanic spraying devices are to be understood as such devices, which facilitate the spraying of a liquid without the use of a propellant. A suitable mechanical spraying device can be used, for example, as spray pump or an elastic container equipped with a spray valve, into which the cosmetic substance in accordance with the invention can be filled under pressure, whereby the elastic container expands and out of which the substance is continuously released due to the contraction of the elastic container upon opening the spray valve.

As hair treatment, the treatment of human hair on the head is to be understood especially for the purpose of the production of a hairstyle or the care of hair.

Example 1:
Hair Fastener

| | | |
|---|---|---|
| 1.50 | g | inorganic/organic hybrid prepolysiloxane from 3-glycidoxy |
| | | propyl trimethoxysilane, 3-triethoxysilyl propyl succinic |
| | | anhydride and 1-methylimidazol |
| 1.50 | g | vinyl pyrrolidone/vinylacetate copolymer |
| 0.20 | g | 1,2-propylenglycol |
| 0.15 | g | perfume |
| 0.03 | g | cetyltrimethyl ammonium chloride |
| 20.21 | g | water |
| 76.41 | g | ethanol |
| 100.00 | g | |

Alternatively, every other of the above described systems
2.) to 10.) can also be used as the hybrid polymer.
Example 2:
Hair Fastener

| | | |
|---|---|---|
| 0.88 | g | inorganic/organic hybrid prepolysiloxane from mercapto |
| | | propyl triethoxysilane and hydrochloric acid |
| 2.63 | g | vinyl pyrrolidone/vinylacetate copolymer |
| 0.20 | g | 1,2-propylenglycol |
| 0.15 | g | perfume |
| 0.05 | g | cetyltrimethylammoniumchloride |
| 59.89 | g | water |
| 46.28 | g | ethanol |
| 100.00 | g | |

Example 3:
Coating Material for Textiles and Leather

| | | |
|---|---|---|
| 1.80 | g | inorganic/organic hybrid prepolysiloxane, trimethoxy- |
| | | phenylsilane, 2,2,2-trifluoroethylamine, tributoxyaluminium |
| | | and acetic acid ethylester |
| 1.20 | g | polyvinyl pyrrolidone |
| 0.10 | g | 2-hydroxy-4-methoxybenzophenone |
| 61.50 | g | water |
| 35.25 | g | ethanol |
| 100.00 | g | |

Example 4:
Corrosion Protection

| | | |
|---|---|---|
| 3.00 | g | inorganic/organic hybrid prepolysiloxane from 3-glycidoxy |
| | | propyl trimethoxysilane, tetramethoxysilane, tributoxy- |
| | | aluminium, tetrapropoxyzirconium and triethanolamine |
| 1.00 | g | polyvinyl buterol (NB) |
| 0.20 | g | 1,2-propylenglycol |
| 18.66 | g | ethanol |
| 70.14 | g | water |
| 100.00 | g | |

Example 5:
Transport Protection

| | | |
|---|---|---|
| 1.63 | g | inorganic/organic hybrid prepolysiloxane from 3-glycidoxy |
| | | propyl trimethoxysilane, tetramethoxysilane, tributoxy- |
| | | aluminium, tetramethoxysilane, tributoxyaluminium, |
| | | tetrapropoxyzirconium and triethanolamine |
| 0.92 | g | inorganic/organic hybrid prepolysiloxane from mercapto |
| | | propyl. triethoxysitane and hydrochloric acid |
| 4.00 | g | vinyl acetate/crotonacid/polyethylenoxid copolymer |
| 0.20 | g | cyclo-tetra (dimethylsiloxane) |
| 13.20 | g | water |
| 40.00 | g | ethanol |
| 40.15 | g | dimethylether |
| 100.00 | g | |

Example 6:
Coating for Fibers

| | | |
|---|---|---|
| 1.53 | g | inorganic/organic hybrid pepolysiloxane from mercapto |
| | | propyl triethoxysilane, and vinyl triethoxysilane and |
| | | hydrochloric acid |
| 2.50 | g | polyvinyl pyrrolidone |
| 0.30 | g | hydroxyethyl cellulose |
| 0.05 | g | mica/titanium oxide/tin oxide-powder |
| | | (Soloron” Silver Sparkle by the firm Merck/Germany) |
| 95.62 | g | water |
| 100.00 | g | |

Example 7:
Color Fastener

| | | |
|---|---|---|
| 0.23 | g | inorg./org. hybrid prepolymer from mercapto propyl |
| | | triethoxysilane and hydrochloric acid |
| 2.50 | g | vinyl acetate/croton acid/polyglycol copolymer |
| 0.20 | g | perfume |
| 0.07 | g | l-amino-4-(2,3′-dehydroxypropyl)amino-5-chlor-2- |
| | | nitrobenzol |
| 0.05 | g | basic brown 17 (C. 1. 12 251) |
| 0.01 | g | basic blue 7 (C. 1. 42 595) |
| 0.0023 | g | basic purple 14 (C. 1. 42 510) |
| 46.94 | g | water |
| 50.00 | g | ethanol |
| 100.00 | g | |

Example 8:
Colorless Nailpolish

| | | |
|---|---|---|
| 6.0 | g | inorg./org. hybrid prepolymer from 3-glycidoxy propyl |
| | | trimethoxysilane, tetramethoxysilane, tributoxyaluminium, |
| | | tetrapropoxyzirrconium and triethanolamine |
| 18.0 | g | nitrocellulose (moist with alcohol 65:35) |
| 4.0 | g | dibutylphthalate |
| 2.0 | g | camphor |
| 40.0 | g | butylacetate |
| 30.0 | g | ethylacetate |
| 100.00 | g | |

1. (Cancelled)

2. (Cancelled)

3. (Twice Amended) The material of claim 8 wherein the networkable organic residue R is selected from the group consisting of alkyl, alkenyl, alkynyl, aryl, arylalkyl, alkylaryl, arylalkenyl, alkenylaryl, alylalkynyl, and alkynylaryl, and wherein the residue can be broken with O-, S- or N-atoms.

4. (Twice Amended) The material of claim 8 wherein the hydrolyzable residue X is selected from the group consisting of alkoxy-, aryloxy-, acyloxy, alkylcarbonyl-, alkoxycarbonyl-groups, halogen, hydrogen and substituted or unsubstituted amino-groups.

5. (Twice Amended) The material of claim 8 wherein the silane of formula (I) is selected from the group consisting of vinyl trialkoxysilane, vinyl triacetoxysilane, amino propyl trialkoxysilane, isocyanato propyl trialkoxysilane, mercapto propyl trialkoxysilane, vinyl trichlorsilane, allyl trialkoxysilane, 3-isocyanato oxypropyl trialkoxysilane, methacryl oxypropenyl trialkoxysilane, 3-methacryl carbonyl oxypropyl trialkoxysilane, p-amino phenyl trialkoxysilane, 3-amino propyl trialkoxysilane, 3-cyano propyl trialkoxysilane, 4-mercapto butyl trialkoxysilane, 6-mercapto hexyl trialkoxysilane, 3-mercapto propyl trialkoxysilane, 3-(ethylendiaimino)-propyl trialkoxysilane, 3-(diethylene triamino)propyl trialkoxysilane, 3-glycidoxy propyl trialkoxysilane, 2-[4-(1,2-epoxy cyclohexyl)]-ethyl trialkoxysilane, and 3-(trialkoxysilyl) propyl succinic anhydride, wherein alkoxy groups mean methoxy- or ethoxy-groups.

6. (Twice Amended) The material of claim 8 wherein the hybrid pre-polymer is combined with network modifying compounds selected from the group consisting of:
a) alkyl-, alkoxy-, halogen-, acyloxy-, hydroxy-, oxyhalogen- or hydroxyhalogen compounds of metals of the transition elements and/or
b) compounds of the formula SiX, and/or
c) compounds of the formula SiR′XR, wherein R′ stands for alkyl-, or aryl-group and R and X have the meanings set forth in claim 8.

7. (Twice Amended) The material of claim 8 wherein the additional film-forming polymer is chosen from the group consisting of synthetic non-ionic film-forming polymers, synthetic film-forming anionic polymers, natural film-forming polymers, amphoteric polymers and cationic polymers.

8. (Amended) A material for the temporary stabilizing and/or functionalizing of biological surfaces, the material being formed by
initially forming cross-linked inorganic-organic networks through hydrolytic precondensation, optionally in the presence of at least one condensation catalyst, of at least one organofunctional silane of the formula (I)
RSiX₃, (I)
wherein X stands for a hydrolizable and condensable group, and R stands for a networkable organic residue, to form hybrid pre-polymers, followed by
adding at least one film-forming polymer that is soluble in at least one of water and alcohol, to form a colloidal solution, and
polymerizing the networkable organic residues of the hybrid pre-polymers to form a specifically detachable, film-forming material.

9. (Amended) The material of claim 8 wherein the networkable organic residue R contains at least one networkable substituent of the group consisting of halogen-, amino-, amide-, aldehyde-, keto-, alkylcarbonyl-, carboxy-, mercapto-, cyano-, hydroxy-, alkoxy-, methacryloxy-, epoxy- and vinyl-groups.

10. (Amended) The material of claim 6 wherein the metals of the transition elements are selected from the group consisting of group III B and group IV A.

11. The material of claim 10 wherein the metals of the transition elements are selected from the group consisting of Ti, Zr and Al.

12. A material for the temporary stabilizing and/or functionalizing of biological surfaces, the material being formed by
initially forming cross-linked inorganic-organic networks through hydrolytic precondensation, optionally in the presence of at least one condensation catalyst, of at least one organofunctional silane of the formula (I)
RSiX₃, (I)
wherein X stands for a hydrolizable and condensable group, and R stands for a networkable organic residue, to form hybrid pre-polymers, followed by
adding at least one film-forming polymer that is soluble in at least one of water and alcohol, to form a colloidal solution,
allowing the colloidal portion of the solution to precipitate on to a biological surface, and
networking the hybrid pre-polymers with each other following the precipitation onto the biological substrate to form a specifically detachable, film-forming material on the biological surface.

13. The material of claim 12 wherein the networking consists essentially of polymerizing the hybrid pre-polymers through reactions of double bonds.

14. The material of claim 12 wherein the networking consists essentially of poly-addition of epoxy resin to network organic side chains.

15. The material of claim 12 wherein said alcohol is selected from aliphatic alcohols with 1 to 4 carbon atoms.

16. A material for the temporary stabilizing and/or functionalizing of biological surfaces, the material being formed by
initially forming cross-linked inorganic-organic networks through hydrolytic precondensation, optionally in the presence of at least one condensation catalyst, of at least one organofunctional silane of the formula (I)
RSiX₃, (I)
wherein X stands for a hydrolizable and condensable group, and R stands for a networkable organic residue, to form hybrid pre-polymers, followed by
adding at least one film-forming polymer that is soluble in at least one of water alcohol, branched- unbranched- or cyclic-hydrocarbon to form a colloidal solution,
applying the colloidal solution to a biological surface so that the colloidal portion of the solution can precipitate on to the biological surface, the precipitation facilitating a networking of the hybrid pre-polymers with each other to form a specifically detachable, film-forming material on the biological surface.

17. The material of any of claims 8, 12 or 16 being formed by a further step of adding a cosmetic additive in an amount of 0.01 to 50 weight-%.

18. The material of claim 17 wherein the cosmetic additive comprises a non-reinforcing, non-ionic or anionic polymer.

19. The material of claim 18 wherein the non-reinforcing polymer consists essentially of polyethylene glycol having a molecular weight of about 600.

20. The material of claim 17 wherein the cosmetic additive comprises a non-reinforcing, natural polymer.

21. The material of claim 17 wherein the cosmetic additive comprises a perfume oil in an amount of 0.01 to 5 weight-%.

22. The material of claim 17 wherein the cosmetic additive comprises a clouding substance consisting essentially of ethyleneglycedistearate in an amount of 0.01 to 5 weight-%.

23. The material of claim 17 wherein the cosmetic additive comprises an anionic, cationic, amphoteric, or non-ionic surfactant.

24. The material of claim 23 wherein the surfactant comprises a fatty alcohol sulfate, an ethoxylized fatty alcohol, a fatty acid alkanolamide or any mixture thereof.

25. The material of claim 23 wherein the surfactant comprises hydrated ricinoleic fatty acids in an amount of 0.1 to weight-%.
